(19) United States
(12) Patent Application Publication
(10) Pub. No.: US 2026/0057485 A1
(43) Pub. Date: Feb. 26, 2026

(54) METHOD AND DEVICE FOR OPTIMIZING IMAGE PROCESSING

(71) Applicant: MEDIATEK INC., Hsinchu City (TW)

(72) Inventors: Si-Pin WENG, Hsinchu City (TW); Yu-Chi SU, Hsinchu City (TW); Yu-Chun CHEN, Hsinchu City (TW); Sheng-Po KUO, Hsinchu City (TW); Chia-Ping CHEN, Hsinchu City (TW)

(21) Appl. No.: 19/307,124

(22) Filed: Aug. 22, 2025

Related U.S. Application Data
(60) Provisional application No. 63/686,259, filed on Aug. 23, 2024.

(51) Int. Cl. G06T 5/50; G06T 5/70; G06T 7/90

(52) U.S. Cl. CPC G06T 5/50; G06T 5/70; G06T 7/90; G06T 2207/10024

(57) ABSTRACT

A method for optimizing image processing is provided. The method is implemented by a processor of a device and includes receiving at least one unprocessed image. The method includes extracting pixels whose pixel values are within one or several specific ranges from the at least one unprocessed image based on application requirements. The method includes performing an image processing operation corresponding to the application requirements on the pixels. The method includes smoothly merging the pixels with the at least one unprocessed image to generate a processed image. The method includes outputting the processed image.

### CROSS REFERENCE TO RELATED APPLICATIONS

This application claims the benefit of U.S. Provisional Application No. 63/686,259, entitled “Using Partial Color Range and Associated Processing Concepts for Optimization Strategies”, filed on Aug. 23, 2024, the entirety of which is incorporated by reference herein.

### TECHNICAL FIELD

The present disclosure generally relates to an image processing mechanism. More specifically, aspects of the present disclosure relate to a method and a device for optimizing image processing.

### BACKGROUND

When applying complex techniques to video or image processing (such as denoising, high dynamic range or quality enhancement tasks), most current methods process the full color range, which usually uses up a lot of computing resources.

Therefore, how to provide a method and a device for optimizing image processing which can effectively save on computing resources while maintaining image quality is an important issue.

### BRIEF SUMMARY

The following summary is illustrative only and is not intended to be limiting in any way. That is, the following summary is provided to introduce concepts, highlights, benefits and advantages of the novel and non-obvious techniques described herein. Select, not all, implementations are described further in the detailed description below. Thus, the following summary is not intended to identify essential features of the claimed subject matter, nor is it intended for use in determining the scope of the claimed subject matter.

Therefore, one of the main purposes of the present disclosure is to provide a method and an electronic device for reducing power consumption.

In an exemplary embodiment, a method for optimizing image processing is provided. The method is implemented by a processor of a device and includes receiving at least one unprocessed image. The method includes extracting pixels whose pixel values are within one or several specific ranges from the at least one unprocessed image based on application requirements. The method includes performing an image processing operation corresponding to the application requirements on the pixels. The method includes smoothly merging the pixels with the at least one unprocessed image to generate a processed image. The method includes outputting the processed image.

In some embodiments, the image processing operation comprises at least one of a noise reduction process, a dehaze process, a blur reduction process, a white balancing (WB)/color adjustment, and an image enhancement.

In some embodiments, the one or several specific ranges partially overlap each other or do not overlap each other.

In some embodiments, a format of the at least one unprocessed image is Bayer Raw, RGB, YUV, YCbCr or Lab.

In some embodiments, when the format of at least one unprocessed image is Bayer Raw or RGB, the one or several specific ranges are color ranges.

In some embodiments, when the format of at least one unprocessed image is YUV, YCbCr or Lab, the pixel values are pixel brightness values and the one or several specific ranges are brightness ranges.

In some embodiments, the image processing operation is parallel-performed on the pixels or is performed step by step on the pixels.

In an exemplary embodiment, a method for optimizing image processing is provided. The method is implemented by a processor of a device and includes receiving at least one unprocessed image. The method includes extracting pixels whose pixel values are within one or several specific ranges from the at least one unprocessed image based on application requirements. The method includes performing an image processing operation corresponding to the application requirements on remaining pixels outside the one or several specific ranges. The method includes smoothly merging the remaining pixels with the at least one unprocessed image to generate a processed image. The method includes outputting the processed image.

In an exemplary embodiment, a device for optimizing image processing is provided. The device comprises one or more processors and one or more computer storage media for storing one or more computer-readable instructions. The processor is configured to drive the computer storage media to execute the following tasks. The following tasks comprise receiving at least one unprocessed image. The following tasks comprise extracting pixels whose pixel values are within one or several specific ranges from the at least one unprocessed image based on application requirements. The following tasks comprise performing an image processing operation corresponding to the application requirements on the pixels. The following tasks comprise smoothly merging the pixels with the at least one unprocessed image to generate a processed image. The following tasks comprise outputting the processed image.

In an exemplary embodiment, a device for optimizing image processing is provided. The device comprises one or more processors and one or more computer storage media for storing one or more computer-readable instructions. The processor is configured to drive the computer storage media to execute the following tasks. The following tasks comprise receiving at least one unprocessed image. The following tasks comprise extracting pixels whose pixel values are within one or several specific ranges from the at least one unprocessed image based on application requirements. The following tasks comprise performing an image processing operation corresponding to the application requirements on remaining pixels outside the one or several specific ranges. The following tasks comprise smoothly merging the remaining pixels with the at least one unprocessed image to generate a processed image. The following tasks comprise outputting the processed image.

### BRIEF DESCRIPTION OF THE DRAWINGS

The accompanying drawings are included to provide a further understanding of the present disclosure, and are incorporated in and constitute a part of the present disclosure. The drawings illustrate implementations of the disclosure and, together with the description, serve to explain the principles of the disclosure. It should be appreciated that the drawings are not necessarily to scale as some components may be shown out of proportion to their size in actual implementation in order to clearly illustrate the concept of the present disclosure.

FIG. 1 is a schematic diagram of an image processing device according to an embodiment of the present disclosure.

FIG. 2 illustrates an exemplary process performed by the image processing circuit according to an embodiment of the present disclosure.

FIG. 3 is a simplified diagram illustrating a process executed by an image processing circuit according to an embodiment of the present disclosure.

FIG. 4 illustrates an exemplary process performed by the image processing circuit according to an embodiment of the present disclosure.

FIG. 5 is a simplified diagram illustrating a process executed by an image processing circuit according to an embodiment of the present disclosure.

FIG. 6 is a simplified diagram illustrating a process executed by an image processing circuit according to an embodiment of the present disclosure.

FIG. 7 illustrates an exemplary process performed by the image processing circuit according to an embodiment of the present disclosure.

FIG. 8 is a simplified diagram illustrating a process executed by an image processing circuit according to an embodiment of the present disclosure.

FIG. 9 is a flowchart showing a method for optimizing image processing according to an embodiment of the present disclosure.

FIG. 10 is a flowchart showing a method for optimizing image processing according to an embodiment of the present disclosure.

FIG. 11 illustrates an exemplary operating environment for implementing embodiments of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using number of the aspects set forth herein. In addition, the scope of the disclosure is intended to cover such an apparatus or method which is practiced using another structure, functionality, or structure and functionality in addition to or other than the various aspects of the disclosure set forth herein. It should be understood that any aspect of the disclosure disclosed herein may be embodied by one or more elements of a claim.

For the purpose of consistency and ease of understanding, like features may be identified (although, in some examples, not shown) by the same numerals in the example figures. However, the features in different implementations may be differed in other respects, and thus shall not be narrowly confined to what is shown in the figures.

The word “exemplary” is used herein to mean “serving as an example, instance, or illustration.” Any aspect described herein as “exemplary” is not necessarily to be construed as preferred or advantageous over other aspects. Furthermore, like numerals refer to like elements throughout the several views, and the articles “a” and “the” includes plural references, unless otherwise specified in the description.

It should be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion. (e.g., “between” versus “directly between”, “adjacent” versus “directly adjacent”, etc.).

The following description is made for the purpose of illustrating the general principles of the disclosure and should not be taken in a limiting sense. The scope of the disclosure is best determined by reference to the appended claims.

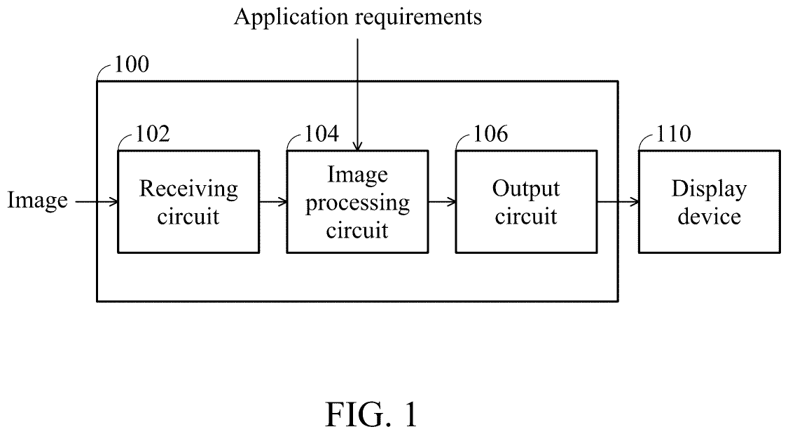

FIG. 1 is a schematic diagram of an image processing device according to an embodiment of the present disclosure. The exemplary image processing device 100 includes but is not limited to: a receiving circuit 102, an image processing circuit 104 and an output circuit 106. The receiving circuit 102 is used to receive one or multiple unprocessed images and provide the unprocessed images to the image processing circuit 104, wherein the multiple unprocessed images are continuous images with small differences, for example, multiple frames of a long exposure video or multiple frames of a video. In particular, the term “unprocessed image(s)” refers to image(s) that have not yet been processed by the method for optimizing image processing according to any embodiment of the present disclosure, rather than image(s) that have never undergone any image processing. The image processing circuit 104 is coupled to the receiving circuit 102, is used to extract pixels whose pixel values are within one or several specific color ranges from the one or multiple unprocessed images based on application requirements, and perform an image processing operation corresponding to the application requirements on the pixels or on remaining pixels outside the one or several specific color ranges, and correspondingly generate a processed image (for example, the processed image obtained by processing one or multiple unprocessed images). In one embodiment, the application requirements may include, but are not limited to, ever-changing environments, darker environments, cold or warm light sources, and/or the like. The output circuit 106 is coupled to the image processing circuit 104 and is used to send the processed image to a display device 110 for playback. In short, the image processing circuit 104 refers to the application requirements to determine which pixels in the one or multiple unprocessed images to be extracted and which pixels need to be processed or should be avoided from processing, so as to obtain enhanced image quality.

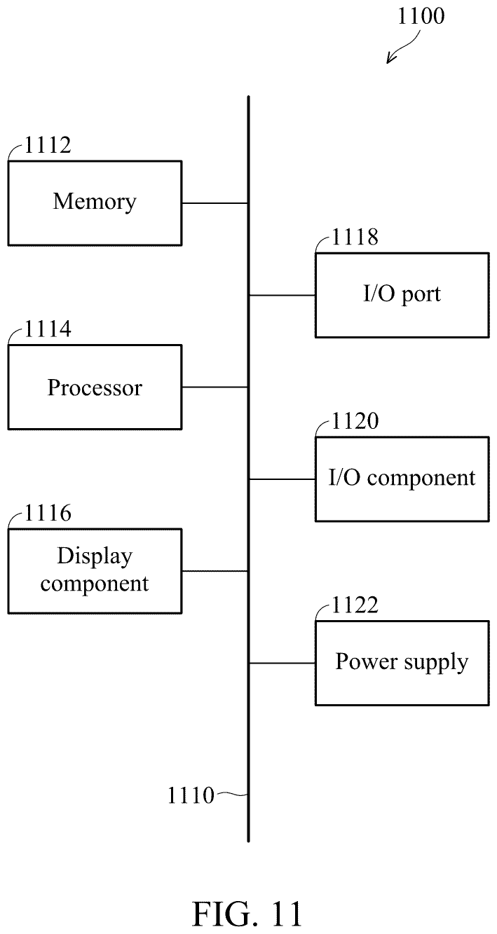

It should be understood that the image processing device 100 shown in FIG. 1 is an example of one suitable device architecture optimizing image processing. The image processing device 100 shown in FIG. 1 may be implemented via any type of electronic device, such as the electronic device 1100 described with reference to FIG. 11, for example.

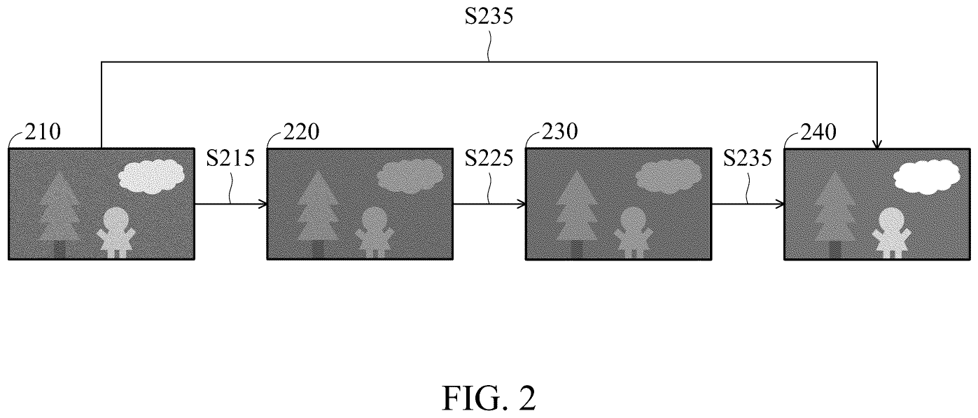

FIG. 2 illustrates an exemplary process performed by the image processing circuit according to an embodiment of the present disclosure.

As shown in FIG. 2, after receiving the unprocessed image 210, the image processing circuit extracts pixels whose pixel values are within a specific color range from the unprocessed image 210 based on application requirements in S215 to obtain the image 220 consisting of the extracted pixels whose pixel values within the specific color range. Then, the image processing circuit performs an image processing operation corresponding to the application requirements on the image 220 in S225 to obtain the image 230. In some embodiments, the image processing operation may comprise at least one of a noise reduction process, a dehaze process, a blur reduction process, a white balancing (WB)/color adjustment, and an image enhancement, but the present disclosure is not limited thereto. Finally, the image processing circuit smoothly merges the image 230 that has undergone the image processing operation with the unprocessed image 210 in S235 to generate a processed image 240.

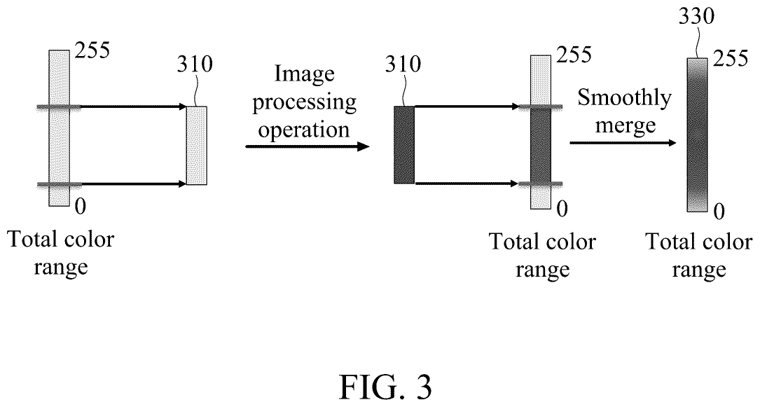

In short, FIG. 2 can be simply explained by FIG. 3, it is assumed that the unprocessed image includes pixels in the total color range of 0˜255. The image processing circuit first extracts pixels within a specific color range 310 from the total color range for processing, and then smoothly merges the processed pixels within the specific color range 310 into the unprocessed image with the total color range to generate a processed image with the total color range 330. For example, it is assumed that a format of the unprocessed image is RGB of 0˜255. For different color channels, the image processing circuit may extract pixels in the same color range (such as the range of the pixel value in the RGB channel is 0 to 127) or different color ranges (such as the ranges of pixel values in the R channel, G channel, and B channel are 0˜127, 128˜255, and 128˜255 respectively) for subsequent processing.

It should be noted that, in an example, the processed pixels within the specific color range 310 may be merged with pixels outside the specific color range 310 of the unprocessed image. In one embodiment, corresponding pixels may be merged evenly (e.g., an even mix of color, brightness, etc. from a first set of pixels and a second set of pixels).

In some embodiments, when the image processing circuit determines that the unprocessed image needs to perform a noise reduction process according to the application requirements, the image processing circuit may extract pixels whose pixel values are in a lower color range, such as the color range of 0˜100, to perform the noise reduction process.

In some embodiments, when the image processing circuit determines that the unprocessed image needs to perform a dehaze process according to the application requirements, the image processing circuit may extract pixels whose pixel values are in a higher color range, such as the color range of 155˜255, to perform the dehaze process.

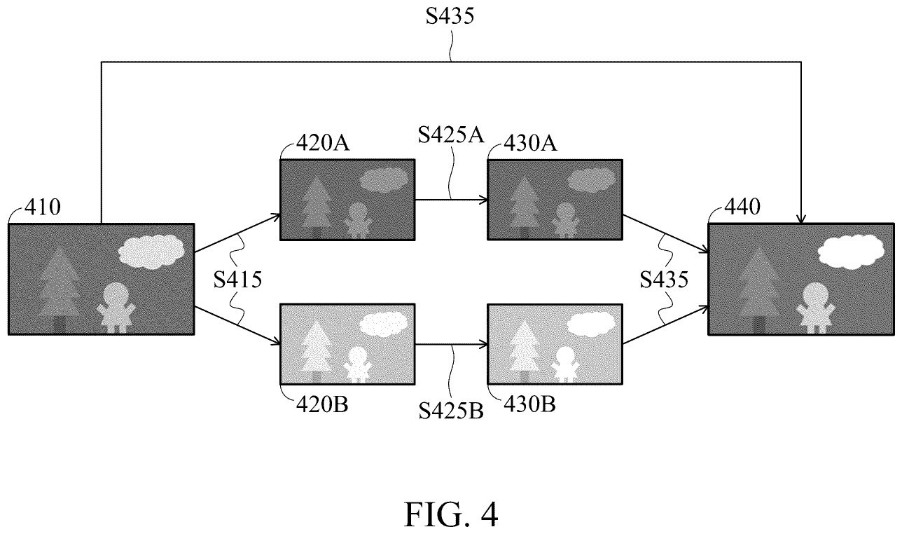

FIG. 4 illustrates an exemplary process performed by the image processing circuit according to an embodiment of the present disclosure.

As shown in FIG. 4, after receiving the unprocessed image 410, the image processing circuit extracts a first group of pixels whose pixel values are within a first color range and a second group of pixels whose pixel values are within a second color range from the unprocessed image 410 based on application requirements in S415 to obtain the image 420A consisting of the first group of pixels and the image 420B consisting of the second group of pixels, wherein the first color range and the second color range partially overlap each other or do not overlap each other. Then, the image processing circuit performs image processing operations corresponding to the application requirements on the image 420A and the image 420B in S425A and S425B, respectively, to obtain the image 430A and 430B, wherein the image processing operations performed on the images 420A and 420B may be the same or different, and the image processing operations may be parallel-performed or performed step by step on the image 420A and the image 420B. In some embodiments, the image processing operation comprises at least one of a noise reduction process, a dehaze process, a blur reduction process, a white balancing (WB)/color adjustment, and an image enhancement, but the present disclosure is not limited thereto. Finally, the image processing circuit smoothly merges the images 430A and 430B that have undergone the image processing operation with the unprocessed image 410 in S435 to generate a processed image 440.

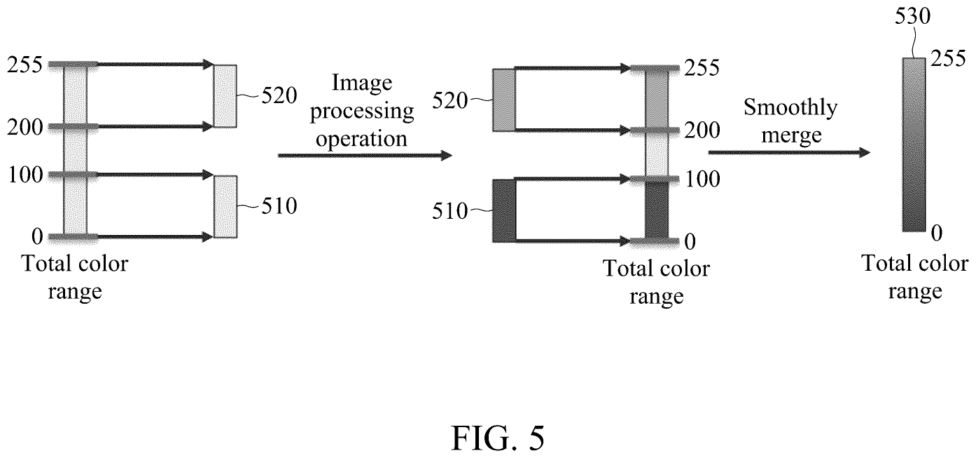

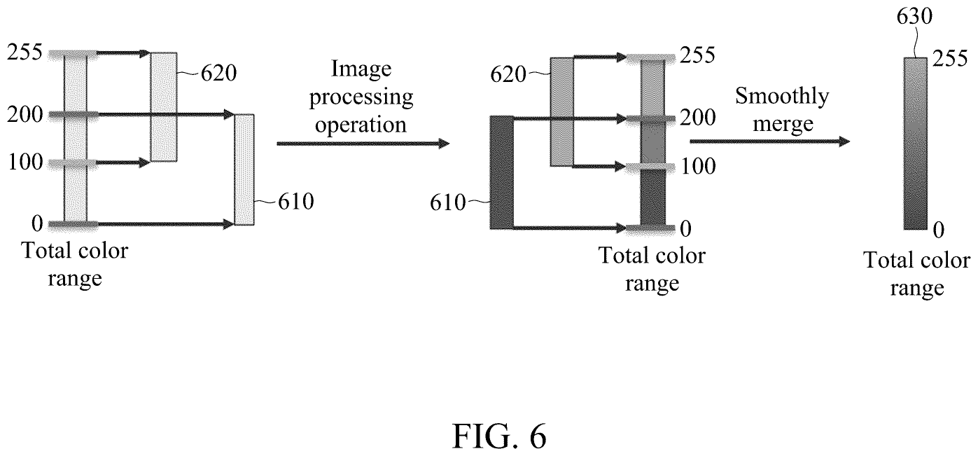

In short, FIG. 4 can be simply explained by FIGS. 5 and 6. In FIG. 5, it is assumed that the unprocessed image includes pixels in the total color range of 0˜255. The image processing circuit first extracts a first group of pixels whose pixel values are within a first color range 0˜100 and a second group of pixels whose pixel values are within a second color range 200˜255 from the total color range for processing, wherein the first color range and the second color range do not overlap with each other. Then, the image processing circuit smoothly merges the processed pixels within the first color range 510 and the second color range 520 into the unprocessed image with the total color range to generate a processed image with the total color range 530.

It should be noted that, in an example, the processed pixels within the specific color ranges 510 and 520 may be merged with pixels outside the specific color ranges 510 and 520 of the unprocessed image. In one embodiment, corresponding pixels may be merged evenly (e.g., an even mix of color, brightness, etc. from a first set of pixels and a second set of pixels).

In FIG. 6, it is assumed that the unprocessed image includes pixels in the total color range of 0˜255. The image processing circuit first extracts a first group of pixels whose pixel values are within a first color range 0˜200 and a second group of pixels whose pixel values are within a second color range 100˜255 from the total color range for processing, wherein the first color range and the second color range partially overlap each other. Then, the image processing circuit smoothly merges the processed pixels within the first color range 610 and the second color range 620 into the unprocessed image with the total color range to generate a processed image with the total color range 630.

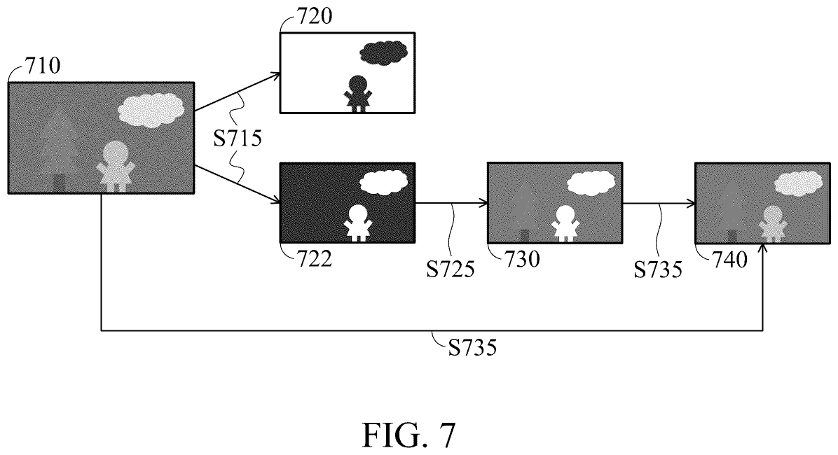

FIG. 7 illustrates an exemplary process performed by the image processing circuit according to an embodiment of the present disclosure.

As shown in FIG. 7, after receiving the unprocessed image 710, the image processing circuit extracts pixels whose pixel values are within a specific color range from the unprocessed image 710 based on application requirements in S715 to obtain the image 720 consisting of the extracted pixels whose pixel values within the specific color range and the image 722 consisting of the remaining pixels outside the specific color range. Then, the image processing circuit performs an image processing operation corresponding to the application requirements on the image 722 in S725 to obtain the image 730. In some embodiments, the image processing operation comprises at least one of a noise reduction process, a dehaze process, a blur reduction process, a white balancing (WB)/color adjustment, and an image enhancement. Finally, the image processing circuit smoothly merges the image 730 that has undergone the image processing operation with the unprocessed image 710 in S735 to generate a processed image 740.

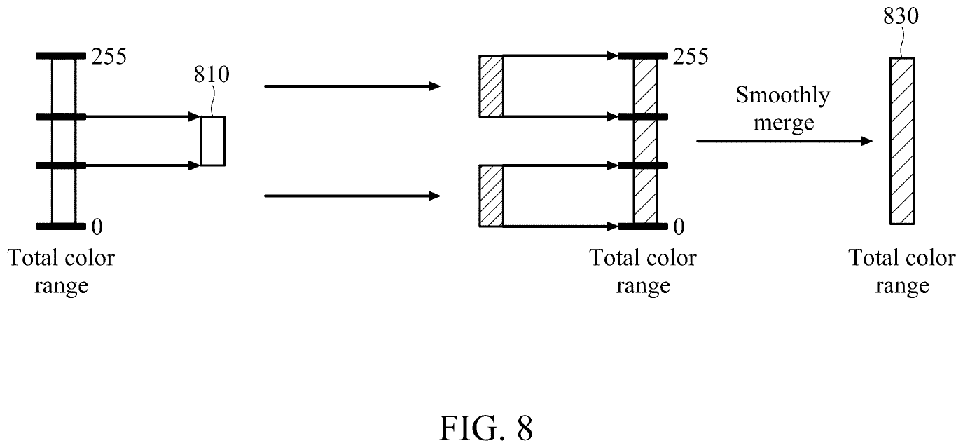

In short, FIG. 7 can be simply explained by FIG. 8, it is assumed that the unprocessed image includes pixels in the total color range of 0˜255. The image processing circuit first extracts pixels within a specific color range 810 from the total color range and skips the extracted pixels within the specific color range 810. Then, the image processing circuit performs the image processing operation corresponding to the application requirements on the remaining pixels outside the specific color range 810 and smoothly merges the processed pixels outside the specific color range 810 into the unprocessed image with the total color range to generate a processed image with the total color range 830.

It should be noted that, in some embodiments of the disclosure, the number of the unprocessed image extracted by the image processing circuit may be extended to more than one, and the disclosure should not be limited to what is shown in FIGS. 2-8. When the number of the unprocessed images is more than one and the unprocessed images are continuous images with small differences, the image processing circuit may extract pixels in different color ranges for each unprocessed image and perform different image processing operations on the extracted pixels in different color ranges.

In another embodiment, a format of the unprocessed image is Bayer Raw, RGB, YUV, YCbCr or Lab. When the format of the unprocessed image is YUV, YCbCr or Lab, the pixel values may be replaced by pixel brightness values. In other words, the image processing circuit may extract pixels whose pixel brightness values are within one or several specific brightness ranges.

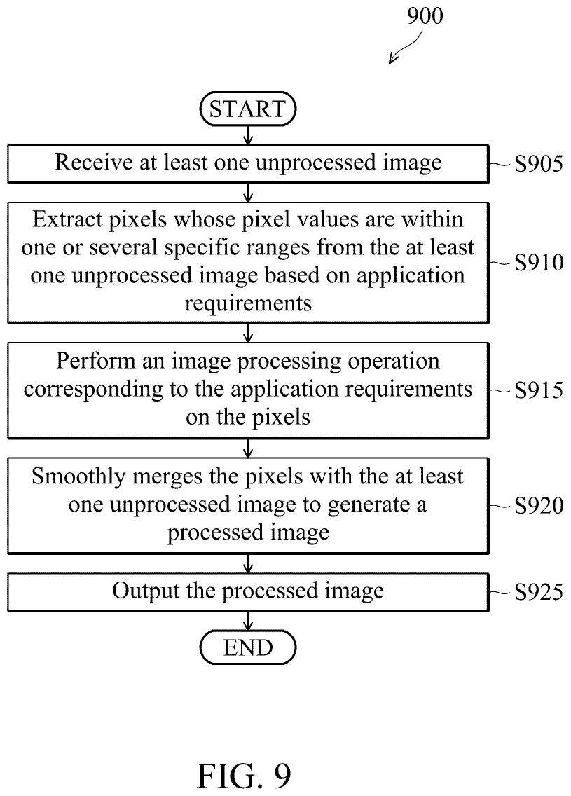

FIG. 9 is a flowchart 900 showing a method for optimizing image processing according to an embodiment of the present disclosure with reference to FIG. 1.

In step S905, the receiving circuit of the electronic device may receive at least one unprocessed image.

In step S910, the image processing circuit of the electronic device extracts pixels whose pixel values are within one or several specific ranges from the at least one unprocessed image based on application requirements.

In step S915, the image processing circuit performs an image processing operation corresponding to the application requirements on the pixels.

In step S920, the image processing circuit smoothly merges the pixels with the at least one unprocessed image to generate a processed image

In step S925, the output circuit of the electronic device outputs the processed image.

In one implementation, the image processing operation comprises at least one of a noise reduction process, a dehaze process, a blur reduction process, a white balancing (WB)/color adjustment, and an image enhancement.

In one implementation, the one or several specific ranges partially overlap each other or do not overlap each other.

In one implementation, a format of the at least one unprocessed image is Bayer Raw, RGB, YUV, YCbCr or Lab. When the format of at least one unprocessed image is Bayer Raw or RGB, the one or several specific ranges are color ranges. When the format of at least one unprocessed image is YUV, YCbCr or Lab, the pixel values are pixel brightness values and the one or several specific ranges are brightness ranges.

In one implementation, the image processing operation is parallel-performed on the pixels or is performed step by step on the pixels.

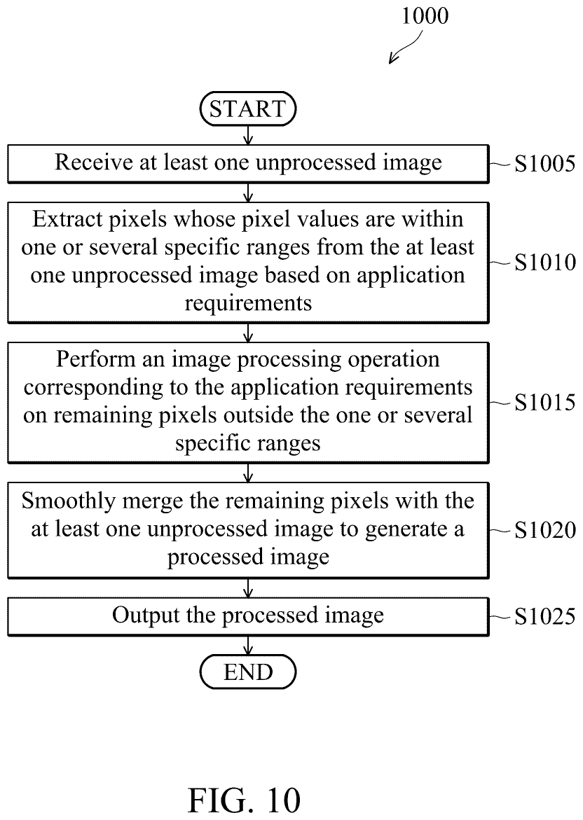

FIG. 10 is a flowchart 1000 showing a method for optimizing image processing according to an embodiment of the present disclosure with reference to FIG. 1.

In step S1005, the receiving circuit of the electronic device may receive at least one unprocessed image.

In step S1010, the image processing circuit of the electronic device extracts pixels whose pixel values are within one or several specific ranges from the at least one unprocessed image based on application requirements.

In step S1015, the image processing circuit performs an image processing operation corresponding to the application requirements on remaining pixels outside the one or several specific ranges.

In step S1020, the image processing circuit smoothly merges the remaining pixels with the at least one unprocessed image to generate a processed image.

In step S1025, the output circuit of the electronic device outputs the processed image.

In one implementation, the image processing operation comprises at least one of a noise reduction process, a dehaze process, a blur reduction process, a white balancing (WB)/color adjustment, and an image enhancement.

In one implementation, the one or several specific ranges partially overlap each other or do not overlap each other.

In one implementation, a format of at least one unprocessed image is Bayer Raw, RGB, YUV, YCbCr or Lab. When the format of at least one unprocessed image is Bayer Raw or RGB, the one or several specific ranges are color ranges. When the format of at least one unprocessed image is YUV, YCbCr or Lab, the pixel values are pixel brightness values and the one or several specific ranges are brightness ranges.

In one implementation, the image processing operation is parallel-performed on the pixels or is performed step by step on the pixels.

As described above, the method and device for optimizing image processing proposed in the present disclosure analyze the application requirements and dynamically extract one or more specific ranges and perform processing on the one or more specific ranges or the remining ranges. In other words, only a specific range is processed instead of the total color range, thus effectively saving computing resources while improving the overall image quality. In addition, to avoid incontiguous artifacts between different color ranges, the present method provides a smoothing process that process that maintains continuity and natural appearance. On the other hand, the present disclosure also proposes the concept of “scalability”, which enables users to flexibly adjust the color range according to various application requirements.

The embodiments described herein, including systems, methods/processes, and/or apparatuses, may be implemented using well known computers, such as the electronic device 1100 shown in FIG. 11. The electronic device 1100 is described as follows, for purposes of illustration.

Referring to FIG. 11, an exemplary operating environment for implementing embodiments of the present disclosure is shown and generally known as an electronic device 1100. The electronic device 1100 is merely an example of a suitable computing environment and is not intended to limit the scope of use or functionality of the disclosure. Neither should the electronic device 1100 be interpreted as having any dependency or requirement relating to any one or combination of components illustrated.

The disclosure may be realized by means of the computer code or machine-useable instructions, including computer-executable instructions such as program modules, being executed by a computer or other machine, such as a camera, a closed-circuit television, a surveillance camera, a personal data assistant (PDA) or other handheld device. Generally, program modules may include routines, programs, objects, components, data structures, etc., and refer to code that performs particular tasks or implements particular abstract data types. The disclosure may be implemented in a variety of system configurations, including hand-held devices, consumer electronics, general-purpose computers, more specialty computing devices, etc. The disclosure may also be implemented in distributed computing environments where tasks are performed by remote-processing devices that are linked by a communication network.

With reference to FIG. 11, the electronic device 1100 may include a bus 1110 that is directly or indirectly coupled to the following devices: one or more memories 1112, one or more processors 1114, one or more display components 1116, one or more input/output (I/O) ports 1118, one or more input/output components 1120, and an illustrative power supply 1122. The bus 1110 may represent one or more kinds of buses (such as an address bus, data bus, or any combination thereof). Although the various blocks of FIG. 11 are shown with lines for the sake of clarity, and in reality, the boundaries of the various components are not specific. For example, the display component such as a display device may be considered an I/O component and the processor may include a memory.

The electronic device 1100 typically includes a variety of computer-readable media. The computer-readable media can be any available media that can be accessed by electronic device 1100 and includes both volatile and nonvolatile media, removable and non-removable media. By way of example, not limitation, computer-readable media may comprise computer storage media and communication media. The computer storage media may include volatile and nonvolatile, removable and non-removable media implemented in any method or technology for storage of information such as computer-readable instructions, data structures, program modules or other data. The computer storage media may include, but not limit to, random access memory (RAM), read-only memory (ROM), electrically-erasable programmable read-only memory (EEPROM), flash memory or other memory technology, compact disc read-only memory (CD-ROM), digital versatile disks (DVD) or other optical disk storage, magnetic cassettes, magnetic tape, magnetic disk storage or other magnetic storage devices, or any other medium which can be used to store the desired information and which can be accessed by the electronic device 1100. The computer storage media may not comprise signals per se.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, but not limitation, communication media includes wired media such as a wired network or direct-wired connection, and wireless media such as acoustic, RF, infrared and other wireless media or any combination thereof.

The memory 1112 may include computer-storage media in the form of volatile and/or nonvolatile memory. The memory may be removable, non-removable, or a combination thereof. Exemplary hardware devices include solid-state memory, hard drives, optical-disc drives, etc. The electronic device 1100 includes one or more processors that read data from various entities such as the memory 1112 or the I/O components 1120. The display component(s) 1116 present data indications to a user or to another device. Exemplary presentation components include a display device, speaker, printing component, vibrating component, etc.

The I/O ports 1118 allow the electronic device 1100 to be logically coupled to other devices including the I/O components 1120, some of which may be embedded. Illustrative components include a microphone, joystick, game pad, satellite dish, scanner, printer, wireless device, etc. The I/O components 1120 may provide a natural user interface (NUI) that processes gestures, voice, or other physiological inputs generated by a user. For example, inputs may be transmitted to an appropriate network element for further processing. The electronic device 1100 may be equipped with depth cameras, such as stereoscopic camera systems, infrared camera systems, RGB camera systems, or any combination thereof, to detect and identify objects. In addition, the electronic device 1100 may be equipped with sensors (e.g., radar, lidar) to periodically sense the surrounding environment within a sensing range and generate sensor information representing the relationship between the electronic device 1100 and the surrounding environment. Furthermore, the electronic device 1100 may be equipped with accelerometers or gyroscopes that enable detection of motion. The output of the accelerometers or gyroscopes may be provided to the electronic device 1100 for display.

Furthermore, the processor 1114 in the electronic device 1100 can execute the program code in the memory 1112 to perform the above-described actions and steps or other descriptions herein.

It should be understood that any specific order or hierarchy of steps in any disclosed process is an example of a sample approach. Based upon design preferences, it should be understood that the specific order or hierarchy of steps in the processes may be rearranged while remaining within the scope of the present disclosure. The accompanying method claims present elements of the various steps in a sample order, and are not meant to be limited to the specific order or hierarchy presented.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the disclosure has been described by way of example and in terms of the preferred embodiments, it should be understood that the disclosure is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. A method for optimizing image processing, wherein the method is implemented by a processor of a device and comprises:
receiving at least one unprocessed image;
extracting pixels whose pixel values are within one or several specific ranges from the at least one unprocessed image based on application requirements;
performing an image processing operation corresponding to the application requirements on the pixels;
smoothly merging the pixels with the at least one unprocessed image to generate a processed image; and
outputting the processed image.

2. The method for optimizing image processing as claimed in claim 1, wherein the image processing operation comprises at least one of a noise reduction process, a dehaze process, a blur reduction process, a white balancing (WB)/color adjustment, and an image enhancement.

3. The method for optimizing image processing as claimed in claim 1, wherein the one or several specific color range partially overlap each other or do not overlap each other.

4. The method for optimizing image processing as claimed in claim 1, wherein a format of the at least one unprocessed image is Bayer Raw, RGB, YUV, YCbCr or Lab.

5. The method for optimizing image processing as claimed in claim 4, wherein when the format of at least one unprocessed image is Bayer Raw or RGB, the one or several specific ranges are color ranges.

6. The method for optimizing image processing as claimed in claim 4, wherein when the format of at least one unprocessed image is YUV, YCbCr or Lab, the pixel values are pixel brightness values and the one or several specific ranges are brightness ranges.

7. The method for optimizing image processing as claimed in claim 1, wherein the image processing operation is parallel-performed on the pixels or is performed step by step on the pixels.

8. A method for optimizing image processing, wherein the method is implemented by a processor of a device and comprises:
receiving at least one unprocessed image;
extracting pixels whose pixel values are within one or several specific ranges from the at least one unprocessed image based on application requirements;
performing an image processing operation corresponding to the application requirements on remaining pixels outside the one or several specific ranges;
smoothly merging the remaining pixels with the at least one unprocessed image to generate a processed image; and
outputting the processed image.

9. The method for optimizing image processing as claimed in claim 8, wherein the image processing operation comprises at least one of a noise reduction process, a dehaze process, a blur reduction process, a white balancing (WB)/color adjustment, and an image enhancement.

10. The method for optimizing image processing as claimed in claim 8, wherein the one or several specific ranges partially overlap each other or do not overlap each other.

11. The method for optimizing image processing as claimed in claim 8, wherein a format of the at least one unprocessed image is Bayer Raw, RGB, YUV, YCbCr or Lab.

12. The method for optimizing image processing as claimed in claim 11, wherein when the format of the at least one unprocessed image is Bayer Raw or RGB, the one or several specific ranges are color ranges.

13. The method for optimizing image processing as claimed in claim 11, wherein when the format of the at least one unprocessed image is YUV, YCbCr or Lab, the pixel values are pixel brightness values and the one or several specific ranges are brightness ranges.

14. The method for optimizing image processing as claimed in claim 8, wherein the image processing operation is parallel-performed on the pixels or is performed step by step on the pixels.

15. A device for optimizing image processing, comprising:
one or more processors; and
one or more computer storage media for storing one or more computer-readable instructions, wherein the processor is configured to drive the computer storage media to execute the following tasks:
receiving at least one unprocessed image;
extracting pixels whose pixel values are within one or several specific ranges from the at least one unprocessed image based on application requirements;
performing an image processing operation corresponding to the application requirements on the pixels;
smoothly merging the pixels with the at least one unprocessed image to generate a processed image; and
outputting the processed image.

16. The device for optimizing image processing as claimed in claim 15, wherein the image processing operation comprises at least one of a noise reduction process, a dehaze process, a blur reduction process, a white balancing (WB)/color adjustment, and an image enhancement.

17. The device for optimizing image processing as claimed in claim 15, wherein the one or several specific ranges partially overlap each other or do not overlap each other.

18. The device for optimizing image processing as claimed in claim 15, wherein a format of the at least one unprocessed image is Bayer Raw, RGB, YUV, YCbCr or Lab.

19. The device for optimizing image processing as claimed in claim 18, wherein when the format of the at least one unprocessed image is Bayer Raw or RGB, the one or several specific ranges are color ranges.

20. The device for optimizing image processing as claimed in claim 18, wherein when the format of the at least one unprocessed image is YUV, YCbCr or Lab, the pixel values are pixel brightness values and the one or several specific ranges are brightness ranges.

21. The device for optimizing image processing as claimed in claim 15, wherein the image processing operation is parallel-performed on the pixels or is performed step by step on the pixels.

22. A device for optimizing image processing, comprising:
one or more processors; and
one or more computer storage media for storing one or more computer-readable instructions, wherein the processor is configured to drive the computer storage media to execute the following tasks:
receiving at least one unprocessed image;
extracting pixels whose pixel values are within one or several specific ranges from the at least one unprocessed image based on application requirements;
performing an image processing operation corresponding to the application requirements on remaining pixels outside the one or several specific ranges;
smoothly merging the remaining pixels with the at least one unprocessed image to generate a processed image; and
outputting the processed image.

23. The device for optimizing image processing as claimed in claim 22, wherein the image processing operation comprises at least one of a noise reduction process, a dehaze process, a blur reduction process, a white balancing (WB)/color adjustment, and an image enhancement.

24. The device for optimizing image processing as claimed in claim 22, wherein the one or several specific ranges partially overlap each other or do not overlap each other.

25. The device for optimizing image processing as claimed in claim 22, wherein a format of the at least one unprocessed image is Bayer Raw, RGB, YUV, YCbCr or Lab.

26. The device for optimizing image processing as claimed in claim 25, wherein when the format of the at least one unprocessed image is Bayer Raw or RGB, the one or several specific ranges are color ranges.

27. The device for optimizing image processing as claimed in claim 25, wherein when the format of the at least one unprocessed image is YUV, YCbCr or Lab, the pixel values are pixel brightness values and the one or several specific ranges are brightness ranges.

28. The device for optimizing image processing as claimed in claim 22, wherein the image processing operation is parallel-performed on the pixels or is performed step by step on the pixels.
